(19) United States
(12) Patent Application Publication
(10) Pub. No.: US 2019/0072727 A1
(43) Pub. Date: Mar. 7, 2019

(54) CONNECTOR MEMBER FOR OPTICAL WAVEGUIDE, OPTICAL CONNECTOR KIT USING SAME, AND OPTICAL INTERCONNECTION OBTAINED THEREBY

(71) Applicant: NITTO DENKO CORPORATION, Ibaraki-shi, Osaka (JP)

(72) Inventors: Naoto Konegawa, Ibaraki-shi (JP); Yuichi Tsujita, Ibaraki-shi (JP)

(73) Assignee: NITTO DENKO CORPORATION, Ibaraki-shi, Osaka (JP)

(21) Appl. No.: 16/090,889

(22) PCT Filed: Apr. 6, 2017
(86) PCT No.: PCT/JP2017/014361

§ 371 Date: Oct. 3, 2018

(30) Foreign Application Priority Data
Apr. 12, 2016 (JP) 2016-079378
Mar. 24, 2017 (JP) 2017-058578

(51) Int. Cl. G02B 6/38; G02B 6/26; G02B 6/42

(52) U.S. Cl. CPC G02B 6/3885; G02B 6/3826; G02B 6/4212; G02B 6/26

(57) ABSTRACT

For the purpose of providing a connector member for an optical waveguide capable of suppressing warpage and deformation of an optical waveguide and making connection with low optical connection losses and an optical connector kit using the same, a connector member for an optical waveguide includes a housing having a placing portion for placing an optical waveguide thereon, and a pair of wall portions extending upwardly from the placing portion, with the optical waveguide therebetween, wherein the wall portions are provided with respective guide pin holes for insertion of positioning guide pins therethrough, and wherein a vertical distance B between a guide pin reference line obtained by connecting the centers of the guide pin holes provided in the respective wall portions and an optical waveguide placing surface of the placing portion satisfies the following formula:

0.018 mm≤B≤0.045 mm.

### TECHNICAL FIELD

The present disclosure relates to a connector member for an optical waveguide which is used for optical connection between an optical waveguide and another light guide, an optical connector kit using the same, and an optical interconnection obtained thereby.

### BACKGROUND ART

In recent years, increases in degree of integration and scale of electronic devices have caused heat generation from and power consumption of electrical interconnections used frequently for connection between boards in the devices and between chips on the boards to become problems. To solve the problems, an optical interconnection technique has been developed which employs light-weight low-heat-generating flexible optical waveguides and optical fibers in place of these electrical interconnections.

For such optical interconnections, the standardization of the shapes, dimensions, and testing methods of optical connectors used for coupling between boards and the like under JIS (Japanese Industrial Standards) has been promoted, and the forms of alignment and coupling between optical connectors have been standardized. Thus, the optical connectors have been easily connectable to other connectors of different types (see NPL 1, for example).

For example, as shown in FIG. 9, a first optical connector in which a PMT ferrule (a general-purpose ferrule for an optical waveguide) 32 is attached to an end portion (a terminus) of an optical waveguide 31 and a second optical connector in which an MT ferrule (a general-purpose ferrule for an optical fiber) 34 is attached to an end portion of a multi-core optical fiber 33 are easily connected (optically coupled) to each other, with the optical axes of the first and second optical connectors positioned with high accuracy by inserting two guide pins 35 into guide pin holes 36 of the first and second optical connectors (although not shown, the MT ferrule 34 is provided with a pair of guide pin holes 36). In the present disclosure, an optical waveguide and an optical fiber are collectively referred to as a “light guide” in some cases.

It is necessary that optical connection losses are minimized for the connection (optical coupling) of two light guides with the use of optical connectors. Thus, a core or a fiber of a light guide is generally positioned with reference to a pair of guide pin holes in an optical connector. When a light guide has a plurality of cores or fibers, an optical connector is designed so that a line obtained by connecting the centers of the cores or fibers as seen in their thickness direction at a connecting surface coincides with a line (referred to hereinafter as a “guide pin reference line”) obtained by connecting the centers of the pair of guide pin holes.

Unfortunately, an optical waveguide, which is typically in the form of a thin film, has a problem such that warpage is more prone to occur in the optical waveguide than in an optical fiber. If a warped optical waveguide is used for an optical connector, the line obtained by connecting the centers of the cores as seen in their thickness direction at the connecting surface is not straight and hence does not coincide with the guide pin reference line. If the optical connector employing such a warped optical waveguide is connected to another connector, the optical axes of the connectors which should be arranged in a horizontal direction along the reference line do not coincide with each other. As a result, large optical connection losses are produced.

To solve such a problem, a technique in which a warpage correction member is provided in an optical connector, and corrects the warpage of an optical waveguide by pressing down the warpage correction member or by pressure of the warpage correction member due to gravity on the warped optical waveguide has been proposed in PTL 1, for example.

### RELATED ART DOCUMENT

### Non-Patent Document

NPL 1: JPCA Standards, “Detail Specification for PMT Connector JPCA-PE03-01-07S-2006”, Japan Electronics Packaging and Circuits Association, May 2006 (Heisei 18).

### Patent Document

PTL 1: JP-A-2015-227958

### SUMMARY OF INVENTION

However, if the warpage correction member presses the warped optical waveguide until the warpage is eliminated, an excessive force is exerted on the optical waveguide to deform the optical waveguide. Asa result, there is apprehension that connection (optical coupling) is not achieved while the optical axes coincide with each other. Also, if the warpage correction member presses the warped optical waveguide until the warpage is eliminated, a force repulsing the pressing is generated. For this reason, there is apprehension that the optical connector is deformed over time to have a problem in decrease in durability.

In view of the foregoing, it is therefore an object of the present disclosure to provide a connector member for an optical waveguide capable of not only eliminating warpage in an optical waveguide but also suppressing the deformation of the optical waveguide and the deformation of an optical connector over time to achieve connection with low optical connection losses, an optical connector kit using the same, and an optical interconnection obtained thereby.

A first aspect of the present disclosure is intended for a connector member for an optical waveguide, which comprises a housing having a placing portion for placing an optical waveguide thereon, and a pair of wall portions extending upwardly from the placing portion, with the optical waveguide therebetween, wherein the wall portions are provided with respective guide pin holes for insertion of positioning guide pins therethrough, and wherein a vertical distance B between a guide pin reference line, obtained by connecting the centers of the guide pin holes provided in the respective wall portions and an optical waveguide placing surface of the placing portion, satisfies the following formula (1):

0.018 mm≤B≤0.045 mm (1)

A second aspect of the present disclosure is intended for an optical connector kit comprising: an optical waveguide having cores and a cladding; and a connector member for an optical waveguide as recited in the first aspect, wherein the optical waveguide is designed so that a vertical thickness H of the cores and a vertical thickness B′ from a surface of the optical waveguide which is in contact with the placing portion to the cores satisfy the following formula (2):

0.018 mm≤H/2+B′≤0.045 mm (2)

In particular, a third aspect of the present disclosure is intended for the optical connector kit of the second aspect wherein the vertical thickness H of the cores and the vertical thickness B′ from the surface of the optical waveguide which is in contact with the placing portion to the cores in the optical waveguide, when the optical waveguide is placed on an optical waveguide placing surface of the placing portion, further satisfy the following formula (3):

0.12 mm<B′/(H/2)<1.2 mm (3)

A fourth aspect of the present disclosure is intended for the optical connector kit of the second and third aspects wherein the vertical thickness H of the cores of the optical wave guide and the vertical thickness B′ from the surface of the optical waveguide which is in contact with the placing portion to the cores, when the optical waveguide is placed on the optical waveguide placing surface of the placing portion, have a relationship expressed by the following formula (4):

D=H/2+B′+C (4)

where C is a vertical distance from a bottom surface of the housing to the optical waveguide placing surface, and D is a vertical distance from the bottom surface of the housing to the guide pin reference line in the connector member for an optical waveguide.

A fifth aspect of the present disclosure is intended for an optical connector kit comprising: an optical waveguide having cores and a cladding; a connector member for an optical waveguide as recited in the first aspect; and a sheet, wherein the sheet is provided between the optical waveguide and the connector member for an optical waveguide, and wherein a vertical thickness H of the cores of the optical waveguide and a vertical thickness B″ from a surface of the sheet which is in contact with the placing portion to the cores, when the optical waveguide is placed on the optical waveguide placing surface of the placing portion with the sheet placed therebetween, satisfy the following formula (5):

0.018 mm≤H/2+B″≤0.045 mm (5)

A sixth aspect of the present disclosure is intended for the optical connector kit of the fifth aspect wherein the vertical thickness H of the cores of the optical waveguide and the vertical thickness B″ from the surface of the sheet which is in contact with the placing portion to the cores, when the optical waveguide is placed on the optical waveguide placing surface of the placing portion with the sheet placed therebetween, further satisfy the following formula (6):

0.12 mm<B″/(H/2)<1.2 mm (6)

A seventh aspect of the present disclosure is intended for the optical connector kit of the fifth or sixth aspect wherein the vertical thickness H of the cores of the optical wave guide and the vertical thickness B″ from the surface of the sheet which is in contact with the placing portion to the cores, when the optical waveguide is placed on the optical waveguide placing surface of the placing portion with the sheet placed therebetween, have a relationship expressed by the following formula (7):

D=H/2+B″+C (7)

where C is a vertical distance from a bottom surface of the housing to the optical waveguide placing surface, and D is a vertical distance from the bottom surface of the housing to the guide pin reference line in the connector member for an optical waveguide.

An eighth aspect of the present disclosure is intended for the optical connector kit of the second to seventh aspects wherein the optical waveguide further includes a functional layer, and the functional layer is provided on the side for contact with the placing portion.

A ninth aspect of the present disclosure is intended for an optical interconnection comprising: an optical waveguide; and a connector member for an optical waveguide as recited in the first aspect. A tenth aspect of the present disclosure is intended for the optical interconnection of the ninth aspect wherein a distance between a front end surface of the housing of the connector member for an optical waveguide and a front end surface of an end portion of the optical waveguide held in the placing portion of the housing is in the range of 5 to 50 μm.

For the purpose of achieving connection with low optical connection losses, the present inventors have directed attention toward the challenge of eliminating warpage of the optical waveguide in the optical connector employing the optical waveguide, and have diligently made studies. As a result, the present inventors have found that, in the connector member for an optical waveguide (referred to hereinafter as a “connector member”) for use in an optical connector, setting a vertical distance between a line obtained by connecting the centers of the pair of guide pin holes provided in the connector member and an optical waveguide placing surface of the connector member in a specific range not only eliminates the warpage of the optical waveguide but also suppresses deformation of the optical waveguide and deformation of the optical connector over time.

The expression “connection with low optical connection losses” used in the present disclosure means that the allowable value of the optical connection losses is not greater than 1 dB.

According to the present disclosure, the vertical distance B between the guide pin reference line and the optical waveguide placing surface of the placing portion satisfies the aforementioned formula (1), so that the connector member is suitable for an optical waveguide having a smaller thickness than conventional products. Thus, a large force is not required to eliminate the warpage of the optical waveguide. If pressed by a cover or the like, the optical waveguide is not significantly deformed but achieves connection (optical coupling) with small misalignment between optical axes. Also, since only a small pressing force is required, a repulsive force is small, and the deformation of the optical connector over time is suppressed. For this reason, the connector member capable of making connection with low optical connection losses at low costs is provided. The expression “connection with small misalignment between optical axes” used in the present disclosure means the connection with a misalignment of not greater than 10 μm between the centers of the optical axes of light guides.

The optical connector kit including: the connector member of the present disclosure; and the optical waveguide having the cores and the cladding, wherein the optical waveguide is designed so that the vertical thickness H of the cores and the vertical thickness B′ from the surface of the optical waveguide which is in contact with the placing portion to the cores satisfy the aforementioned formula (2) provides the optical connector with lower optical connection losses because variations in thickness of the optical waveguide are reduced in addition to the effects produced by the connector member of the present disclosure. Also, the optical connector facilitating the connection to a connector employing a fiber is provided because the optical waveguide is designed so that the vertical thickness H of the cores of the optical waveguide and the vertical thickness B′ from the surface of the optical waveguide which is in contact with the placing portion to the cores satisfy the aforementioned formula (2).

In particular, the optical connector kit wherein the vertical thickness H of the cores and the vertical thickness B′ from the surface of the optical waveguide which is in contact with the placing portion to the cores in the optical waveguide further satisfy the following formula (3) reduces stresses resulting from a difference in linear expansion between the cores and the cladding to suppress the occurrence of warpage, thereby providing the optical connector with lower optical connection losses. Also, stresses in the process of attaching the optical waveguide to the connector member are suppressed, so that the optical connector in which deformation is suppressed is provided. Further, stresses due to environmental temperature change are reduced in the optical waveguide, so that the optical connector in which deformation over time is suppressed.

The optical connector kit wherein the vertical thickness H of the cores of the optical waveguide and the vertical thickness B′ from the surface of the optical waveguide which is in contact with the placing portion to the cores have a relationship expressed by the aforementioned formula (4) where C is the vertical distance from the bottom surface of the housing to the optical waveguide placing surface and D is the vertical distance from the bottom surface of the housing to the guide pin reference line in the connector member provides the optical connector with lower optical coupling losses because the position control of the cores and cladding in the thickness direction is facilitated in the case where the optical waveguide is attached to the connector member, with an adhesive layer or the like therebetween.

The optical connector kit comprising: the connector member for an optical waveguide according to the present disclosure; the optical waveguide having the cores and the cladding; and the sheet, wherein the sheet is provided between the optical waveguide and the connector member for an optical waveguide, and wherein the vertical thickness H of the cores of the optical waveguide and the vertical thickness B″ from the surface of the sheet which is in contact with the placing portion to the cores satisfy the aforementioned formula (5) provides the optical connector with lower optical connection losses because variations in thickness of the optical waveguide is reduced in addition to the effects produced by the connector member of the present disclosure. Also, the optical connector facilitating the connection to a connector employing a fiber is provided because the optical waveguide is designed so that the vertical thickness H of the cores of the optical waveguide and the vertical thickness B″ from the surface of the sheet which is in contact with the placing portion to the cores satisfy the aforementioned formula (5). Moreover, the properties of the sheet improve its functions such as impact resistance, a vibration-proof property, a flame-retardant property, an adhesive property, and the like.

In particular, the optical connector kit wherein the vertical thickness H of the cores of the optical waveguide and the vertical thickness B″ from the surface of the sheet which is in contact with the placing portion to the cores further satisfy the aforementioned formula (6) reduces stresses resulting from a difference in linear expansion between the cores and the cladding to suppress the occurrence of warpage, thereby providing the optical connector with lower optical connection losses. Also, stresses in the process of attaching the optical waveguide to the connector member are suppressed, so that the optical connector in which deformation is suppressed is provided. Further, stresses due to environmental temperature change are reduced in the optical waveguide, so that the optical connector in which deformation over time is suppressed.

The optical connector kit wherein the vertical thickness H of the cores of the optical waveguide and the vertical thickness B″ from the surface of the sheet which is in contact with the placing portion to the cores have a relationship expressed by the aforementioned formula (7) where C is the vertical distance from the bottom surface of the housing to the optical waveguide placing surface and D is the vertical distance from the bottom surface of the housing to the guide pin reference line in the connector member for an optical waveguide provides the optical connector with lower optical coupling losses because the position control of the cores and cladding in the thickness direction is facilitated in the case where the optical connector is attached to the connector member, with an adhesive layer or the like therebetween.

When the optical waveguide further includes a functional layer and the functional layer is provided on the side for contact with the placing portion, functions such as impact resistance, a vibration-proof property, a flame-retardant property, an adhesive property, and the like are imparted to the optical waveguide itself. This provides the optical connector much more excellent in durability.

The optical interconnection having a connection structure by means of the optical connector is capable of providing a high-quality optical connection structure that is low in costs and low in optical connection losses. In particular, the optical interconnection wherein the distance between the front end surface of the housing of the connector member for an optical waveguide and the front end surface of the end portion of the optical waveguide held in the placing portion of the housing is in the range of 5 to 50 μm prevents damage to the front end surface of the end portion of the optical waveguide in the optical connection structure even if connection to and disconnection from an optical connector in which another light guide is held are repeated. Therefore, the optical connection losses are less prone to increase, and satisfactory long-term use is achieved. Also, the optical interconnection is preferable because the distance between the end surface of a target for connection thereto and the end portion of the optical waveguide held by this connector member is short enough to substantially neglect the influence upon optical connection losses.

### BRIEF DESCRIPTION OF DRAWINGS

FIG. 1 is a perspective view of an optical connector obtained using an optical connector kit according to one embodiment of the present disclosure.

FIG. 2 is an illustration of the optical connector.

FIG. 3 is an illustration of a connector member used for the optical connector.

FIG. 4A is a perspective view partially showing a modification of the connector member; and FIG. 4B is an illustration thereof.

FIG. 5A is an illustration partially showing a modification of a cladding of an optical waveguide used for the optical connector; and FIGS. 5B and 5C are illustrations partially showing modifications of the optical connector.

FIG. 6 is an illustration of an optical interconnection having a connection structure using the optical connector.

FIG. 7 is a view illustrating a method of evaluating the optical waveguide in inventive and comparative examples of the present disclosure.

FIG. 8 is a view illustrating a method of evaluating the connector member in the inventive and comparative examples of the present disclosure.

FIG. 9 is an illustration of a connection structure using a general optical connector.

### DESCRIPTION OF EMBODIMENTS

Next, embodiments according to the present disclosure will now be described in detail with reference to the drawings. It should be noted that the present disclosure is not limited to the embodiments to be described below.

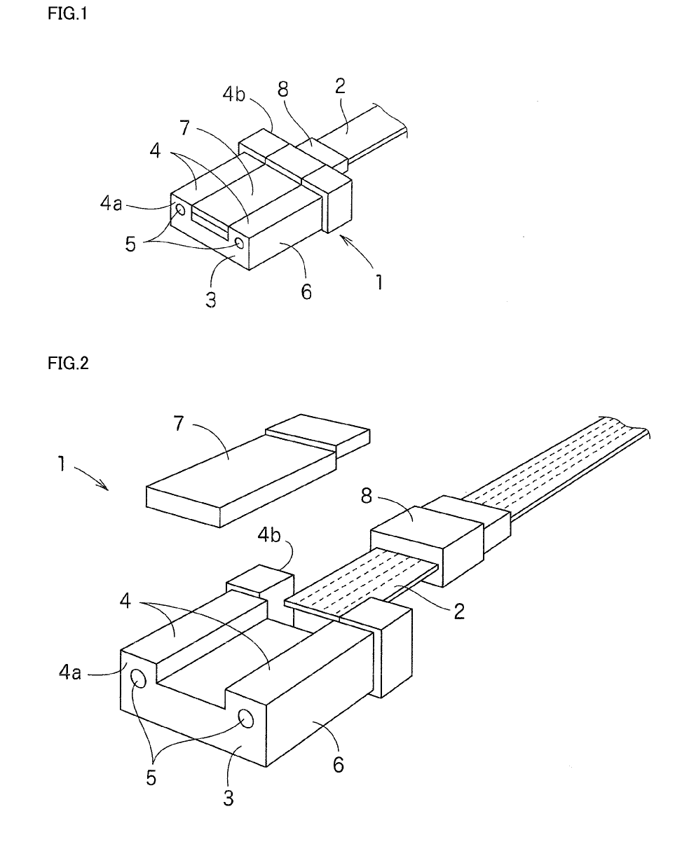

FIG. 1 shows an optical connector obtained using an optical connector kit according to the present disclosure, and FIG. 2 illustrates the configuration of the optical connector. The optical connector kit used for the optical connector includes a connector member 1 and an optical waveguide 2. The connector member 1 includes: a housing 6 having a placing portion 3 for placing the optical waveguide 2 thereon, and a pair of wall portions 4 extending upwardly from the placing portion 3, with the optical waveguide 2 therebetween; and a cover 7 for fixing the optical waveguide 2 placed on the placing portion 3 by abutting against the optical waveguide 2. The components are shown schematically in FIGS. 1 and 2. The thickness, size and the like of the components shown in FIGS. 1 and 2 are different from the actual ones (the same applies to the subsequent figures).

In the connector member 1, the pair of wall portions 4 of the housing 6 have a front end surface 4a on the side for abutment with a different optical connector and used for connection. The front end surface 4a is provided with guide pin holes 5 for insertion of guide pins used for connection to the different optical connector and for positioning during the placement of the optical waveguide 2 therethrough. The guide pin holes 5 extend from the front end surface 4a to a base end surface 4b where an end portion of the optical waveguide 2 is inserted.

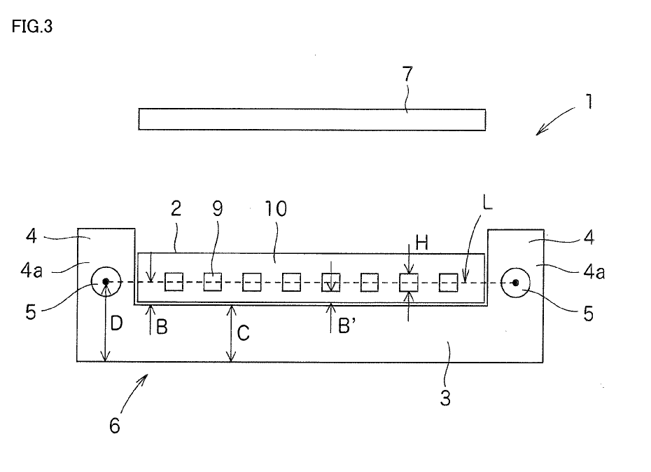

As shown in FIG. 3, the housing 6 of the connector member 1 is designed so that a vertical distance B between a guide pin reference line L obtained by connecting the centers of the guide pin holes 5 and a placing surface of the placing portion 3 on which the optical waveguide 2 is placed satisfies Formula (1) below. This is a striking feature of the present disclosure. In FIG. 3, a gap is shown as provided between the housing 6 and the optical waveguide 2 in the connector member 1. This gap is shown for purposes of illustration to make a clear distinction between the components, and is different from the actual one (the same applies to the subsequent figures).

0.018 mm≤B≤0.045 mm (1)

In the connector member 1, the vertical distance B between the guide pin reference line L and the placing surface of the placing portion 3 on which the optical waveguide 2 is placed is in a predetermined range shorter than that of conventional products. This allows the use of an optical waveguide 2 having a thickness smaller than that of the conventional products, and does not require a large force for the elimination of warpage, if any, in the optical waveguide 2. Thus, only a small pressing force of the cover 7 is required, so that the optical waveguide 2 is not significantly deformed. Accordingly, the repulsive force of the optical waveguide 2 is decreased. This suppresses the deformation of the optical connector for a long time. Thus, the optical connector low in cost, excellent in durability, and capable of achieving optical coupling with the optical axes more coinciding with each other is provided.

In particular, preferable is the connector member 1 in which a vertical thickness H of cores 9 of the optical waveguide 2 and a vertical thickness B′ from a surface of the optical waveguide 2 which is in contact with the placing portion 3 to the cores 9 have a relationship expressed by Formula (4) below where C is a vertical distance from the bottom surface of the housing 6 to the optical waveguide placing surface, and D is a vertical distance from the bottom surface of the housing 6 to the guide pin reference line L. The relationship expressed by Formula (4) between these vertical thicknesses H and B′ facilitates the position control of the cores 9 and a cladding 10 in the thickness direction independently of the thickness of an adhesive layer or the like in the case where the optical connector is provided by attaching the optical waveguide 2 to the connector member 1, with the adhesive layer or the like therebetween. This provides the optical connector with lower optical connection losses. Also preferable is the vertical distance C in the range of 1.205 mm to 1.232 mm from the bottom surface of the housing 6 to the optical waveguide placing surface, which further facilitates the position control in the thickness direction.

D=H/2+B′+C (4)

The housing 6 and the cover 7 used for the connector member 1 may be formed by transfer molding, molding, injection molding, or the like with the use of a resin impermeable to light or a dark-colored or black resin, for example, which is made impermeable to light by adding coloring matter such as a pigment or an extender such as titanium to a resin permeable to light.

The optical waveguide 2 used in combination with the connector member 1 as the optical connector kit includes the plurality of cores 9 and the cladding 10 (including an under cladding and an over cladding) provided over and under the cores 9 so as to hold the cores 9 between portions thereof, as shown in FIG. 3, for example.

Such an optical waveguide 2 is obtained by a method of sequentially patterning and stacking the cladding 10 and the cores 9 by a photolithographic process or the like using an exposure mask, for example, with the use of ultraviolet curable resins such as epoxy resins. The optical waveguide 2 is designed to include the cores 9 having a refractive index (optical refraction index) higher than that of the cladding 10 so that an optical signal entering the cores 9 is transmitted only through the cores 9.

In particular, preferable is the optical waveguide 2 in which the vertical thickness H of the cores 9 and the vertical thickness B′ from the surface of the optical waveguide 2 which is in contact with the placing portion 3 to the cores 9 satisfy Formula (2) below. This is because, when the vertical thickness H of the cores 9 and the vertical thickness B′ from the surface of the optical waveguide 2 which is in contact with the placing portion 3 to the cores 9 satisfy Formula (2) below, there is an excellent balance between reduction in variations in the thickness of the optical waveguide 2 and the ease of connection to a connector employing a fiber.

0.018 mm≤H/2+B′≤0.045 mm (2)

Also preferable is the optical waveguide 2 in which the vertical thickness H of the cores 9 and the vertical thickness B′ from the surface of the optical waveguide 2 which is in contact with the placing portion 3 to the cores 9 satisfy Formula (3) below. This is because, when the vertical thickness H of the cores 9 and the vertical thickness B′ from the surface of the optical waveguide 2 which is in contact with the placing portion 3 to the cores 9 satisfy Formula (3) below, stresses resulting from a difference in linear expansion between the cores 9 and the cladding 10 are reduced, so that the occurrence of warpage is suppressed. This alleviates stresses in the process of attaching the optical waveguide 2 to the connector member 1 to thereby provide the optical connector in which deformation is suppressed. Further, stresses due to environmental temperature change are reduced in the optical waveguide 2, so that the deformation of the optical connector over time is suppressed.

0.12 mm<B′/(H/2)<1.2 mm (3)

The vertical thickness B′ of the cladding 10 is preferably in the range of 0.003 mm to 0.028 mm, and the vertical thickness H of the cores 9 is preferably in the range of 0.035 mm to 0.05 mm. When the vertical thickness B′ of the cladding 10 and the vertical thickness H of the cores 9 are within the aforementioned ranges, the optical connector more excellent in durability and capable of achieving optical coupling with the optical axes more coinciding with each other is provided.

The optical connector kit is provided with accessories to the connector member 1 which include guide pins for insertion into the guide pin holes 5 and a boot portion 8 for combination with the housing 6, with the optical waveguide 2 inserted therethrough. These accessories are similar to the conventional components, and will not be shown and described. A certain connector member includes a boot portion formed integrally with the housing on the base end surface side of the housing. In such a case, there is no need to combine the boot portion as a separate member with the connector member.

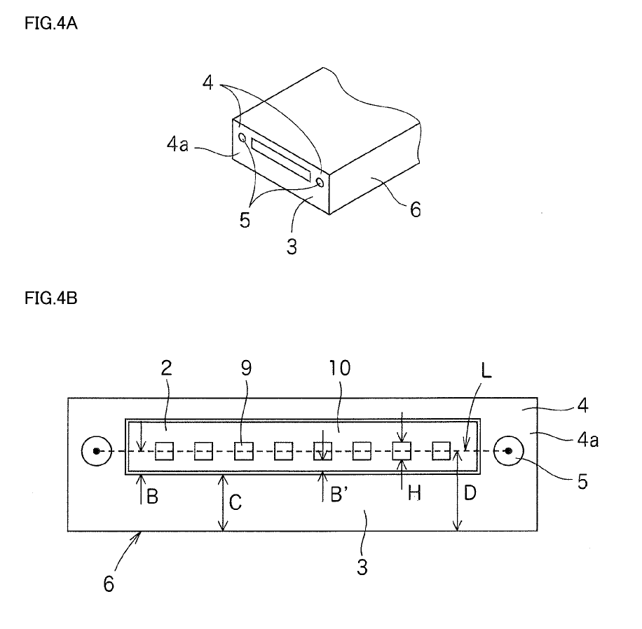

In the connector member 1 according to the aforementioned embodiment, the housing 6 includes the placing portion 3 and the pair of wall portions 4 extending upwardly from the placing portion 3, with the optical waveguide 2 therebetween, as shown FIG. 3. Thus, the housing 6 is of an inclined U shape as seen from the direction of the front end surface 4a, and has an opening blocked with the cover 7. However, as schematically shown in FIG. 4A, the housing 6 may be originally in an entirely tubular shape. In this case, the cover 7 is unnecessary. Also, in this case, the distances and the thicknesses may be set, as appropriate, as shown in FIG. 4B.

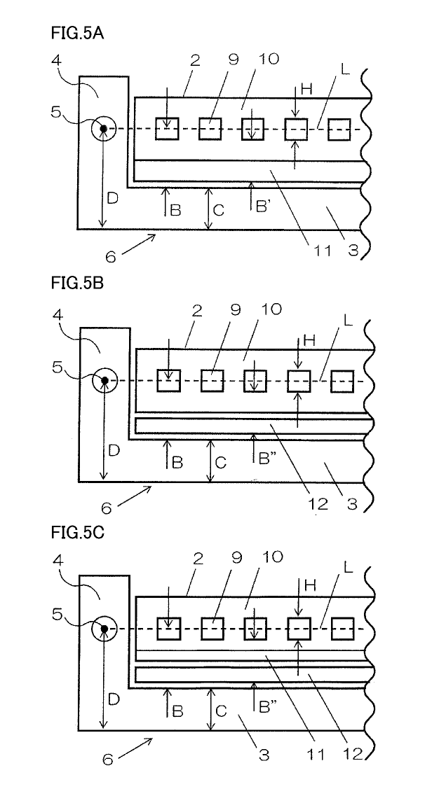

In the aforementioned embodiment, the cladding 10 of the optical waveguide 2 includes the under cladding and the over cladding. The cladding 10 may further include at least one functional layer 11 as designated by the reference numeral 11 in FIG. 5A. In this case, the vertical thickness B′ from the surface of the optical waveguide 2 which is in contact with the placing portion 3 to the cores 9 is a distance including the functional layer 11, as shown in FIG. 5A. This configuration, in which functions to be imparted to the functional layer 11 are appropriately designed, is capable of increasing the performance of the optical connector kit.

Examples of the functional layer 11 include a flame-retardant layer, a high hardness layer, a soil-resistant layer, a slip property imparting layer, an anti-static layer, a thickness adjusting layer, a smoothness imparting layer, and an adhesive layer. Also, the functional layer 11 may contain a variety of additives. Examples of the additives include a flame retarder, a hard coat material, a long-chain aliphatic compound, a lubricant, an electrically conductive polymer, a leveling agent, a variety of fillers, a plasticizer, and a mold release agent. These may be used either alone or in combination. Further, the at least one functional layer 11 may include one or more functional layers 11. The functional layer 11 is provided by stacking at least one material composition forming the functional layer, for example, on the side of the optical waveguide 2 which contacts the placing portion surface by a coating technique or the like.

In the aforementioned embodiment, the optical waveguide 2 is placed directly on the placing portion 3 of the connector member 1. However, the optical waveguide 2 and the placing portion 3 of the connector member 1 need not be in direct contact with each other. For example, as shown in FIG. 5B, the optical waveguide 2 may be placed on the placing portion 3 of the connector member 1, with at least one sheet 12 therebetween. In this case, it is necessary that Formula (5) below is satisfied where H is the vertical thickness of the cores 9 of the optical waveguide 2, and B″ is a vertical thickness from a surface of the sheet 12 which is in contact with the placing portion 3 to the cores 9. This configuration, in which the thickness and function of the sheet 12 are appropriately designed, is capable of increasing the performance of the optical connector kit more conveniently in addition to producing effects similar to those of the aforementioned embodiment. In FIG. 5B, gaps are shown as provided between the sheet 12 and the housing 6 and between the sheet 12 and the optical waveguide 2. These gaps are shown for purposes of illustration to make a clear distinction between the components, and are different from the actual ones (the same applies to the subsequent figures).

0.018 mm≤H/2+B″≤0.045 mm (5)

When the vertical thickness H of the cores 9 of the optical waveguide 2 and the vertical thickness B″ from the surface of the sheet 12 which is in contact with the placing portion 3 to the cores 9 further satisfy Formula (6) below, stresses resulting from a difference in linear expansion between the cores 9 and the cladding 10 are reduced as in the aforementioned embodiment, so that the occurrence of warpage is suppressed. This alleviates stresses in the process of attaching the optical waveguide 2 to the connector member 1 to thereby provide the optical connector in which deformation is suppressed. Further, stresses due to environmental temperature change are reduced in the optical waveguide 2, so that the deformation of the optical connector over time is suppressed.

0.12 mm<B″/(H/2)<1.2 mm (6)

Further, when the vertical thickness H of the cores 9 of the optical waveguide 2 and the vertical thickness B″ from the surface of the sheet 12 which is in contact with the placing portion 3 to the cores 9 have a relationship expressed by Formula (7) below where C is the vertical distance from the bottom surface of the housing 6 to the optical waveguide placing surface, and D is the vertical distance from the bottom surface of the housing 6 to the guide pin reference line L in the connector member 1, the position control of the cores 9 and the cladding 10 in the thickness direction is facilitated independently of the thickness of an adhesive layer or the like in the case where the optical connector is provided by attaching the optical waveguide 2 to the connector member 1, with the adhesive layer or the like therebetween. This provides the optical connector with lower optical connection losses. Also, when the vertical distance C from the bottom surface of the housing 6 to the optical waveguide placing surface is in the range of 1.205 mm to 1.232 mm, the position control in the thickness direction is further facilitated.

D=H/2+B″+C (7)

Examples of the sheet 12 include sheets having functions (a flame-retardant property, a high hardness property, a soil-resistant property, slip property impartment, an anti-static property, thickness adjustment, smoothness impartment, and an adhesive property) similar to those of the aforementioned functional layer. Also, the sheet 12 may contain a variety of additives. Examples of the additives include a flame retarder, a hard coat material, a long-chain aliphatic compound, a lubricant, an electrically conductive polymer, a leveling agent, a variety of fillers, a plasticizer, and a mold release agent. These may be used either alone or in combination. Further, the at least one sheet 12 may include one or more sheets 12.

The optical connector kit including the sheet 12 may be provided, for example, by placing the sheet 12 on the placing portion 3 of the housing 6 before the optical waveguide 2 is placed on the housing 6 of the connector member 1, and then placing the optical waveguide 2 on the sheet 12. The sheet 12 may be fixed to at least one of the surfaces of the housing 6 and the cladding 10 which are in contact with the placing portion 3 or may be fixed to neither thereof. Examples of a method of fixing the sheet 12 include, but not limited to, adhesion, sticking, and fusion.

As shown in FIG. 5C, in the case where the optical waveguide 2 is provided with the functional layer 11, the optical waveguide 2 may be, of course, placed on the placing portion 3 of the housing 6, with the sheet 12 therebetween. In this case, both of the advantages of the provision of the functional layer 11 and the sheet 12 are obtained.

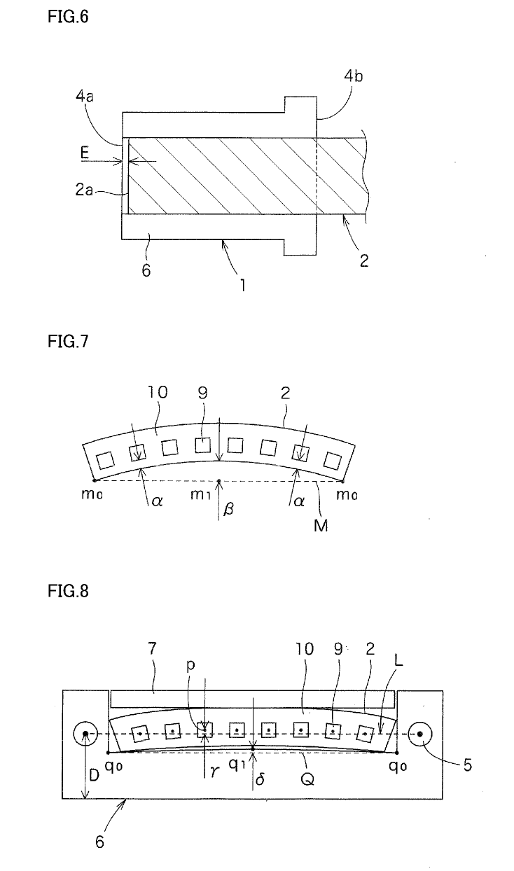

Next, an exemplary optical interconnection having a connection structure using the aforementioned optical connector is shown in FIG. 6. FIG. 6 is partial view showing that an end portion of the optical waveguide 2 is held in the housing 6. A front end surface 2a of the end portion of the optical waveguide 2 held in the housing 6 is disposed a distance E inwardly from the front end surface 4a of the housing 6 of the connector member 1 for an optical waveguide.

The aforementioned optical interconnection is capable of providing a high-quality optical connection structure that is low in costs and low in optical connection losses. In addition, the front end surface 2a of the end portion of the optical waveguide 2 is disposed inwardly from the front end surface 4a of the housing 6 of the connector member 1 for an optical waveguide. Thus, the front end surface 2a of the end portion of the optical waveguide 2 is not damaged in the optical connection structure even if connection to and disconnection from an optical connector in which another light guide is held are repeated. Therefore, the optical connection losses are less prone to increase, and satisfactory long-term use is achieved.

The distance E between the front end surface 4a of the housing 6 of the connector member 1 for an optical waveguide and the front end surface 2a of the end portion of the optical waveguide 2 held in the housing 6 is preferably in the range of 5 to 50 μm, and more preferably in the range of 5 to 20 μm. If the distance E is too long, the distance from a target for optical coupling is increased, and optical connection losses are accordingly increased. Thus, there is apprehension that the rate of the increase in optical connection losses is non-negligible, which is not preferable. On the other hand, if the distance E is too short, there is apprehension that the front end surface 2a of the end portion of the optical waveguide 2 is damaged by protrusions unpreferably in the cases where the optical fiber protrudes from the front end surface of a target optical connector for connection thereto and where the front end surface itself of the target optical connector for connection thereto is uneven.

### EXAMPLES

Next, inventive examples of the present disclosure will be described in conjunction with a comparative example. It should be noted that the present disclosure is not limited to the inventive examples to be described below within the scope of the present disclosure. The term “parts” used herein means “parts by weight”.

[Material for Formation of Under Cladding and Over Cladding]

First, materials to be described below were prepared as materials for the formation of an optical waveguide.

Component a: 60 parts of an epoxy resin (jER1001 available from Mitsubishi Chemical Corporation).

Component b: 30 parts of an epoxy resin (EHPE3150 available from Daicel Corporation).

Component c: 10 parts of an epoxy resin (EXA-4816 available from DIC Corporation).

Component d: 0.5 parts of a photo-acid generator (CPI-101A available from San-Apro Ltd.).

Component e: 0.5 parts of an antioxidant (Songnox1010 available from Kyodo Chemical Co., Ltd.).

Component f: 0.5 parts of an antioxidant (HCA available from Sanko Co., Ltd.).

Component g: 50 parts of ethyl lactate (a solvent).

A material for the formation of an under cladding and an over cladding was prepared by mixing these components a to g together.

[Material for Formation of Cores]

Component h: 50 parts of an epoxy resin (YDCN-700-3 available from Nippon Steel & Sumikin Chemical Co., Ltd.).

Component i: 30 parts of an epoxy resin (jER1002 available from Mitsubishi Chemical Corporation).

Component j: 20 parts of an epoxy resin (OGSOL PG-100 available from Osaka Gas Chemicals Co., Ltd.).

Component k: 0.5 parts of a photo-acid generator (CPI-101A available from San-Apro Ltd.).

Component l: 0.5 parts of an antioxidant (Songnox1010 available from Kyodo Chemical Co., Ltd.).

Component m: 0.125 parts of an antioxidant (HCA available from Sanko Co., Ltd.).

Component n: 50 parts of ethyl lactate (a solvent).

A material for the formation of cores was prepared by mixing these components h to n together.

### Inventive Examples 1 to 10 and Comparative Example 1

<Preparation of Connector Member>

First, polyphenylene sulfide (PPS) resin was injection-molded in a predetermined metal mold, whereby the housing 6, the cover 7, and the boot portion 8 shown in FIG. 1 were produced. In this step, the vertical distance B, the vertical distance C, and the vertical distance D of the housing 6 were dimensions as listed in TABLE 1 below. The aforementioned vertical distances are as described below. The cover 7 is formed to have a thickness large enough to abut with the upper surface of the optical waveguide 2 placed on the placing portion 3.

Vertical distance B: a vertical distance between the guide pin reference line L obtained by connecting the centers of the guide pin holes 5 provided in the pair of wall portions 4 and the optical waveguide placing surface of the placing portion 3.

Vertical distance C: a vertical distance from the bottom surface of the housing 6 to the optical waveguide placing surface.

Vertical distance D: a vertical distance from the bottom surface of the housing 6 to the guide pin reference line L.

<Preparation of Optical Waveguide>

A polyimide film having a width of 3 mm and a thickness of 15 μm was prepared as an electric circuit board. The under cladding, the cores, and the over cladding were formed using the aforementioned materials in a stacked manner on one surface of the electric circuit board by patterning by means of predetermined mask exposure. Thus, the optical waveguide 2 schematically shown in FIG. 3 was produced so as to have dimensions (in mm) listed in TABLE 1 below (a total length of 5 cm). In the optical waveguide 2, the number of cores was 12, the width of the cores was 40 μm, and the spacing between the cores was 250 μm.

<Assembly of Optical Connector>

The optical waveguide 2 having a lower surface (a surface on the side of the placing portion of the housing) coated with an adhesive agent was set in a predetermined position of the placing portion 3 of the housing 6. Then, the cover 7 was put on the optical waveguide 2, and the boot portion 8 was fitted on the optical waveguide 2. After pressing with torque applied, the adhesive agent was cured, so that all of the components were integrated together. Thus, an optical connector was produced. Only in Inventive Example 3, the adhesive agent was applied also on the upper surface of the optical waveguide 2, and the optical waveguide 2 was set in the placing portion 3 of the housing 6.

Items listed in TABLE 1 below were evaluated for each of Inventive Examples 1 to 10 and Comparative Example 1 thus obtained, and the results were also listed in TABLE 1. A method of evaluating each of the items is as follows.

[Thickness Variation]

Prior to the assembly of the optical connector, the optical waveguide 2 for use in the optical connector in each of Inventive Examples 1 to 10 and Comparative Example 1 was observed with a measuring microscope (BF-3017D available from Mitutoyo Corporation), and a thickness α(with reference to FIG. 7) from a surface of the cladding 10 on the side for contact with the housing 6 to a surface of each of the cores 9 was measured for each channel (for each of the 12 cores). A difference between maximum and minimum values was obtained from the obtained measurement values, and was applied to indices to be described below, whereby variations in thickness of the optical waveguide 2 were evaluated.

∘∘ (very good): not greater than 5 μm

∘ (good): greater than 5 μm and not greater than 7 μm

Δ (acceptable): greater than 7 μm and not greater than 10 μm

x (poor): greater than 10 μm

[Amount of Warpage]

Prior to the assembly of the optical connector, the optical waveguide 2 for use in the optical connector in each of Inventive Examples 1 to 10 and Comparative Example 1 was observed with a measuring microscope (BF-3017D available from Mitutoyo Corporation), and the shortest distance β (with reference to FIG. 7) from a point m₁ at which a phantom line M is divided into two equal parts to the surface of the cladding 10 on the side for contact with the housing 6 was measured, the phantom line M being obtained by connecting opposite ends m₀ of the surface of the cladding 10 on the side for contact with the housing 6. The obtained shortest distance β was applied to indices to be described below, whereby the amount of warpage of the optical waveguide 2 was evaluated.

∘∘ (very good): not greater than 15 μm

∘ (good): greater than 15 μm and not greater than 30 μm

Δ (acceptable): greater than 30 μm and not greater than 40 μm

x (poor): greater than 40 μm

[Core Misalignment]

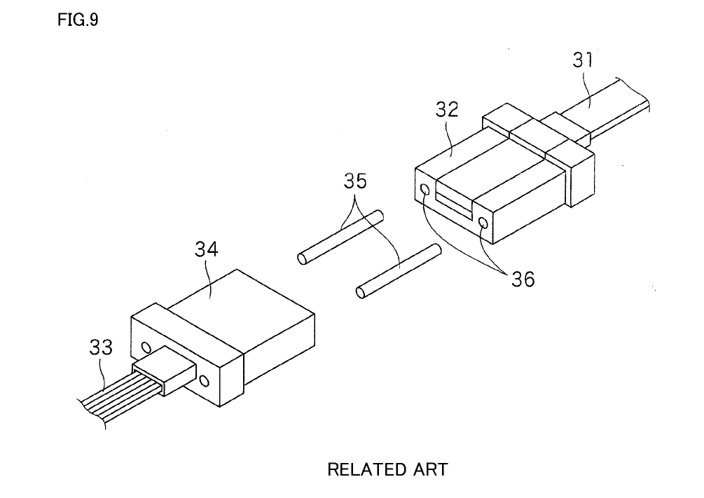

The optical waveguide 2 used in the optical connector in each of Inventive Examples 1 to 10 and Comparative Example 1 was observed with a measuring microscope (BF-3017D available from Mitutoyo Corporation), and the shortest distance γ (with reference to FIG. 8) between the guide pin reference line L obtained by connecting the centers of the pair of guide pin holes 5 and a thickness center point p of each of the cores 9 was measured for each channel (for each of the 12 cores). The average of the obtained shortest distances γ was applied to indices to be described below, whereby misalignment of the cores 9 was evaluated.

∘∘ (very good): not greater than 8 μm

∘ (good): greater than 8 μm and not greater than 12 μm

Δ (acceptable): greater than 12 μm and not greater than 20 μm

x (poor): greater than 20 μm

[Housing Deformation]

The housing 6 of the optical connector in each of Inventive Examples 1 to 10 and Comparative Example 1 was observed with a measuring microscope (BF-3017D available from Mitutoyo Corporation), and the shortest distance δ (with reference to FIG. 8) from a point q₁ at which a phantom line Q is divided into two equal parts to the surface of the housing 6 was measured, the phantom line Q being obtained by connecting opposite ends (points of contact with a wall portion) q₀ of the placing portion 3 of the housing 6. The obtained shortest distance δ was applied to indices to be described below, whereby deformation of the housing 6 was evaluated.

∘∘ (very good): not greater than 3 μm

∘ (good): greater than 3 μm and not greater than 5 μm

x (poor): greater than 5 μm

TABLE 1

| | | Inv. | Inv. | Inv. | Inv. | Inv. | Inv. | Inv. | Inv. | Inv. | Inv. | Comp. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 | Ex. 10 | Ex. 1 |
| Housing | Vertical | 0.045 | 0.045 | 0.04 | 0.018 | 0.028 | 0.0275 | 0.04 | 0.0425 | 0.041 | 0.044 | 0.05 |
| | distance B | | | | | | | | | | | |
| | Vertical | 1.205 | 1.205 | 1.21 | 1.232 | 1.222 | 1.223 | 1.21 | 1.208 | 1.209 | 1.206 | 1.2 |
| | distance C | | | | | | | | | | | |
| | Vertical | 1.25 | 1.25 | 1.25 | 1.25 | 1.25 | 1.25 | 1.25 | 1.25 | 1.25 | 1.25 | 1.25 |
| | distance D | | | | | | | | | | | |
| Optical waveguide | Thickness B′ | 0.028 | 0.025 | 0.018 | 0.003 | 0.003 | 0.01 | 0.02 | 0.02 | 0.022 | 0.024 | 0.03 |
| | Thickness H | 0.04 | 0.04 | 0.04 | 0.030 | 0.05 | 0.035 | 0.04 | 0.045 | 0.038 | 0.04 | 0.04 |
| H/2 + B′ | | 0.048 | 0.045 | 0.038 | 0.018 | 0.028 | 0.0275 | 0.04 | 0.0425 | 0.041 | 0.044 | 0.05 |
| B′/(H/2) | | 1.40 | 1.25 | 0.90 | 0.20 | 0.12 | 0.57 | 1.00 | 0.89 | 1.16 | 1.20 | 1.50 |
| H/2 + B′ + C | | 1.253 | 1.250 | 1.248 | 1.250 | 1.250 | 1.251 | 1.250 | 1.251 | 1.250 | 1.250 | 1.250 |
| Optical waveguide | Thickness | Δ | Δ | ∘∘ | ∘ | ∘ | ∘∘ | ∘∘ | ∘∘ | Δ | Δ | x |
| | variation | | | | | | | | | | | |
| | Amount of | Δ | ∘ | ∘∘ | ∘∘ | ∘∘ | ∘∘ | ∘∘ | ∘∘ | ∘∘ | ∘∘ | x |
| | warpage | | | | | | | | | | | |
| Optical connector | Core | Δ | Δ | Δ | ∘∘ | ∘∘ | ∘∘ | ∘∘ | ∘∘ | ∘ | ∘ | x |
| | misalignment | | | | | | | | | | | |
| | Housing | ∘ | ∘ | ∘ | ∘∘ | ∘∘ | ∘∘ | ∘ | ∘ | ∘ | ∘ | x |
| | deformation | | | | | | | | | | | |

(in mm)

The aforementioned results in TABLE 1 show that the thickness variations and the amount of warpage are suppressed in the optical waveguide 2 in each of Inventive Examples 1 to 10 and that the misalignment of the cores 9 and the deformation of the housing 6 are suppressed in the optical connector in each of Inventive Examples 1 to 10. In particular, it is found that Inventive Examples 4 to 8, in which at least three of the four evaluation items are evaluated as “∘∘”, are especially excellent. On the other hand, it is found that Comparative Example 1 corresponding to a conventional general-purpose product, in which all of the evaluation items are evaluated as “x”, provides the optical connector with high optical connection losses. Further, optical connectors in which the cladding of the optical waveguide 2 was provided with the functional layer 11 and optical connectors in which the optical waveguide 2 was placed on the placing portion 3 of the connector member 1, with the sheet 12 therebetween, pursuant to Inventive Examples 1 to 10 were evaluated in the same manner as in Inventive Examples 1 to 10. As a result, excellent results similar to those in Inventive Examples 1 to 10 were obtained.

Although specific forms in the present disclosure have been described in the aforementioned examples, the aforementioned examples should be considered as merely illustrative and not restrictive. It is contemplated that various modifications evident to those skilled in the art could be made without departing from the scope of the present disclosure.

The present disclosure is applicable to an optical connector capable of making connection with low optical connection losses.

### REFERENCE SIGNS LIST

1 Connector member for optical waveguide
2 Optical waveguide
3 Placing portion
4 Wall portions
5 Guide pin holes
6 Housing
L Guide pin reference line
B Vertical distance

1. A connector member for an optical waveguide, comprising:
a housing having a placing portion for placing an optical waveguide thereon, and a pair of wall portions extending upwardly from the placing portion, with the optical waveguide therebetween,
wherein the wall portions are provided with respective guide pin holes for insertion of positioning guide pins therethrough, and
wherein a vertical distance B between a guide pin reference line, obtained by connecting the centers of the guide pin holes provided in the respective wall portions, and an optical waveguide placing surface of the placing portion satisfies the following formula (1):
0.018 mm≤B≤0.045 mm (1).

2. An optical connector kit, comprising:
an optical waveguide having cores and a cladding; and
the connector member for an optical waveguide according to claim 1,
wherein the optical waveguide has a vertical thickness H of the cores and a vertical thickness B′ from a surface of the optical waveguide which is in contact with the placing portion to the cores which satisfies the following formula (2):
0.018 mm≤H/2+B′≤0.045 mm (2).

3. The optical connector kit according to claim 2, wherein the vertical thickness H of the cores and the vertical thickness B′ from the surface of the optical waveguide which is in contact with the placing portion to the cores in the optical waveguide, when the optical waveguide is placed on an optical waveguide placing surface of the placing portion, further satisfy the following formula (3):
0.12 mm<B′/(H/2)<1.2 mm (3).

4. The optical connector kit according to claim 2, wherein the vertical thickness H of the cores of the optical waveguide and the vertical thickness B′ from the surface of the optical waveguide which is in contact with the placing portion to the cores, when the optical waveguide is placed on the optical waveguide placing surface of the placing portion, have a relationship expressed by the following formula (4):
D=H/2+B′+C (4)
where C is a vertical distance from a bottom surface of the housing to the optical waveguide placing surface, and D is a vertical distance from the bottom surface of the housing to the guide pin reference line in the connector member for an optical waveguide.

5. An optical connector kit, comprising:
an optical waveguide having cores and a cladding;
the connector member for an optical waveguide according to claim 1; and
a sheet,
wherein the sheet is configured to be provided between the optical waveguide and the connector member for an optical waveguide, and
wherein a vertical thickness H of the cores of the optical waveguide and a vertical thickness B″ from a surface of the sheet which is in contact with the placing portion to the cores, when the optical waveguide is placed on the optical waveguide placing surface of the placing portion with the sheet placed therebetween, satisfy the following formula (5):
0.018 mm≤H/2+B″≤0.045 mm (5).

6. The optical connector kit according to claim 5, wherein the vertical thickness H of the cores of the optical waveguide and the vertical thickness B″ from the surface of the sheet which is in contact with the placing portion to the cores, when the optical waveguide is placed on the optical waveguide placing surface of the placing portion with the sheet placed therebetween, further satisfy the following formula (6):
0.12 mm<B″/(H/2)<1.2 mm (6).

7. The optical connector kit according to claim 5, wherein the vertical thickness H of the cores of the optical waveguide and the vertical thickness B″ from the surface of the sheet which is in contact with the placing portion to the cores, when the optical waveguide is placed on the optical waveguide placing surface of the placing portion with the sheet placed therebetween, have a relationship expressed by the following formula (7):
D=H/2+B″+C (7)
where C is a vertical distance from a bottom surface of the housing to the optical waveguide placing surface, and D is a vertical distance from the bottom surface of the housing to the guide pin reference line in the connector member for an optical waveguide.

8. The optical connector kit according to claim 2, wherein the optical waveguide further includes a functional layer, and the functional layer is provided on the side for contact with the placing portion.

9. An optical interconnection comprising:
an optical waveguide; and
a connector member for an optical waveguide as recited in claim 1.

10. The optical interconnection according to claim 9, wherein a distance between a front end surface of the housing of the connector member for an optical waveguide and a front end surface of an end portion of the optical waveguide held in the placing portion of the housing is in a range of 5 to 50 μm.
